(19) United States
(12) Patent Application Publication
(10) Pub. No.: US 2007/0006176 A1
(43) Pub. Date: Jan. 4, 2007

(54) Source code replacement via dynamic build analysis and command interception

(75) Inventors: Gabriel Spil, Kirkland, WA (US); Charles Martin Zalinski, Redmond, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/172,636

(22) Filed: Jul. 1, 2005

(51) Int. Cl. G06F 9/44

(52) U.S. Cl. 717/135

(57) ABSTRACT

A system that facilitates modification of build system module and/or aggregate without side effects of affecting the original build system. An analysis engine facilitates parsing build system artifacts (e.g., source files, makefiles) thereby generating a list of decomposable binary files. A user can be presented with the list of modules and associated aggregates to modify. Once selected, the aggregates can be copied and persisted into a data repository. A build system simulation can generate a decomposed aggregation graph along with the physical memory/store location of the selected aggregates. This information can be employed in the compilation of modules of the build system. A build-time interception of linker commands from the build system can prompt replacement of build system aggregates with user modified aggregates.

### BACKGROUND

Modular programming involves dissecting the design of a program into individual components (e.g., modules) that can be programmed and tested independently. As such, this separation is often a requirement for effective development and maintenance of large programs and projects. Today, modular programming has evolved into object-oriented programming, which provides formal rules for developing self-contained software modules.

Large scale build systems can be complicated and unwieldy to manage. These systems can contain complex construction rules for the dynamic generation of binaries (e.g., modules) based upon user selection or environmental variables. One method for achieving this is by constructing binary modules from code libraries. Code libraries can be self-contained or further decomposed into code library construction units. For example, a code library can be a complex aggregate (e.g., includes additional code library data) or an atomic (e.g., simple) aggregate.

Because complex rules are frequently hierarchical, recursive or driven by the build system environment they can most often be too complex for human analysis. As such, computer analysis is required. Moreover, modifications to complex build system rules can introduce unwanted side effects.

In large or complex composition hierarchies, modifying one aggregate (e.g., a code library) will affect all down stream libraries or modules that contain the aggregate. In many cases it is useful to modify portions of source code that contribute to certain modules in a complex build system without accidentally contributing to modules that are not to be modified. It is also frequently useful to only modify portions of source code at certain times or under certain conditions, thus not affecting all users of the build system at all times. Conventional facilities do not make this limited modification possible. In other words, traditional systems do not allow users to replace build system aggregates defined as code libraries with corresponding modified versions of these libraries in a manner which causes no unwanted side effects to multiple modules or multiple users of the build system.

### SUMMARY

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The invention disclosed and claimed herein, in one aspect thereof, comprises a system that facilitates a user to modify a single module and/or aggregate without side effects of affecting the underlying (e.g., original) build system. In other words, an aspect of the invention can enable users to replace build system aggregates defined as code libraries with corresponding modified versions of these libraries in a manner which causes no unwanted side effects to multiple modules and/or multiple users of the build system.

Another aspect includes an analysis engine that facilitates parsing build system artifacts (e.g., source files, makefiles) thereby generating a list of decomposable binary files. As well, a user can be presented with the list of modules to modify. In accordance therewith, the system can determine the aggregation of the selected module(s).

Other aspects employ rendering (e.g., presenting) the determined aggregates to a user whereby the user can select aggregates to modify. The selected aggregates can be copied and persisted into a data repository. In still other aspects, aggregates can be rendered and/or selected automatically via rules-based logic and/or artificial intelligence reasoning techniques.

Still other aspects can employ a build system simulation that generates a decomposed aggregation graph along with the physical memory/store location of the aggregates. This information can be employed in the compilation of modules of the build system. For example, a physical location of aggregates can be different in the case of modified aggregate versus unmodified aggregates. In one aspect, modified aggregates can be persisted into a user-specific data repository.

Another aspect is directed to a system that employs build-time interception of linker commands from the build system. This interception can prompt replacement of build system aggregates with user modified aggregates. In doing so, the linker command can be altered to point to the user modified aggregate(s). In this aspect, side effects and/or modifications to the build system are avoided.

In yet other aspects thereof, rules-based logic and/or artificial intelligence (AI)-reasoning components can be provided that employ a programmed, probabilistic and/or statistical-based analysis to effect, prognose or infer an action that a user desires to be automatically performed.

To the accomplishment of the foregoing and related ends, certain illustrative aspects of the invention are described herein in connection with the following description and the annexed drawings. These aspects are indicative, however, of but a few of the various ways in which the principles of the invention can be employed and the subject invention is intended to include all such aspects and their equivalents. Other advantages and novel features of the invention will become apparent from the following detailed description of the invention when considered in conjunction with the drawings.

### BRIEF DESCRIPTION OF THE DRAWINGS

FIG. 1 illustrates a general component block diagram of a system that facilitates simulating a build system in accordance with an aspect of the subject innovation.

FIG. 2 illustrates a general component block diagram of a system that employs a selection component that facilitates module and/or aggregate selection in accordance with an aspect.

FIG. 3 illustrates an exemplary graphical representation of a decomposable binary module list in accordance with an aspect.

FIG. 4 illustrates an exemplary component block diagram that facilitates source code replacement via dynamic build analysis, parsing and command interception.

FIG. 5 illustrates a block diagram of an exemplary analysis system in accordance with the innovation.

FIG. 6 illustrates a block component schematic of a system that employs an analysis and replacement engine to simulate a build system in accordance with an aspect.

FIG. 7 illustrates a block diagram of an exemplary system that employs parsing, editing and interception components to simulate a build system.

FIG. 8 illustrates an exemplary flow chart of procedures of an analysis phase in accordance with a disclosed aspect.

FIG. 9 illustrates a general component block diagram of a system that represents a pre-link phase in accordance with an aspect of the subject innovation.

FIG. 10 illustrates an exemplary flow chart of procedures of a pre-link phase in accordance with a disclosed aspect.

FIG. 11 illustrates a general component block diagram of a system that represents a link phase in accordance with an aspect of the subject innovation.

FIG. 12 illustrates an exemplary flow chart of procedures of a link phase in accordance with a disclosed aspect.

FIG. 13 illustrates an architecture including a rules-based logic component that can automate functionality in accordance with a defined rule in accordance with an aspect of the innovation.

FIG. 14 illustrates an architecture including an artificial intelligence-based component that can automate functionality in accordance with an aspect.

FIG. 15 illustrates a graph that facilitates a heuristic mechanism of selecting, copying, presenting, etc., in accordance with an aspect.

FIG. 16 illustrates a block diagram of a computer operable to execute the disclosed architecture.

FIG. 17 illustrates a schematic block diagram of an exemplary computing environment in accordance with the subject invention.

### DETAILED DESCRIPTION

The following terms are used throughout the description, the definitions of which are provided herein to assist in understanding various aspects of the subject invention.

Module or Binary Module can also be referred to as an “absolute load module.” These modules can refer to binary files that can be loaded and executed on a target computer hardware component.

Code Libraries can refer to collections of object files in a portable unit of target machine code that can be added to or compose a binary module. The portable unit of target machine code is usually a file.

Compiler can refer to a tool that generates object files from programming language source code. In one example, a compiler can be software that translates a program written in a high-level programming language (e.g., COBOL, C, . . . ) into machine language. A compiler usually initially generates assembly language and subsequently translates the assembly language into machine language. A utility known as a “Linker”, “Link Editor” or “Link Utility” can then combine all required machine language modules into an executable program that can run in the computer.

Object Files can refer to the machine level code that is the result of the compilation of source code by the Compiler.

Linker, Link Editor or Link Utility can refer to the tool that generates Binary Modules from Object File(s) and/or Code Libraries.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the term to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

The invention is now described with reference to the drawings, wherein like reference numerals are used to refer to like elements throughout. In the following description, for purposes of explanation, numerous specific details are set forth in order to provide a thorough understanding of the subject invention. It may be evident, however, that the invention can be practiced without these specific details. In other instances, well-known structures and devices are shown in block diagram form in order to facilitate describing the invention.

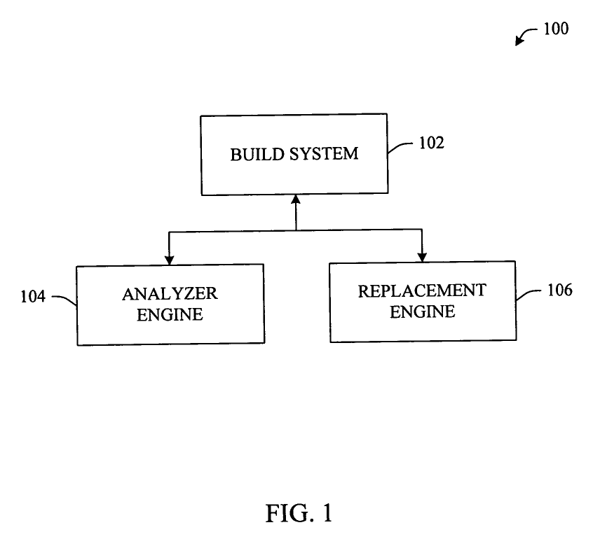

Referring initially to FIG. 1, a system 100 that facilitates simulating a build system is shown in accordance with an aspect. Generally, the system 100 of FIG. 1, can include a build system 102, an analysis engine 104 and a replacement engine 106. As will be better understood upon a review of the figures that follow, the build system 102 can construct multiple modules (e.g., binary modules). Further, as described supra, one drawback of conventional build systems is the inability to simulate a build that corresponds to a particular application. Also, in accordance with conventional systems, a modification of an individual module of the build system would affect any subsequent operation of the build system. This situation can be particularly undesirable in scenarios where multiple users and/or applications are accessing a common build system.

As shown, the system 100 can include an analysis engine 104. The analysis engine 104 can interrogate the build system thereby identifying any decomposable modules included therein. Additionally, the analysis engine 104 can facilitate decomposing the identified modules into one or more aggregates (e.g., artifacts). Accordingly, the analysis engine 104 can persist a subset of the one or more aggregates into a data repository or other storage component. In one aspect, a user and/or application can identify the subset of aggregates to persist. As will be discussed in greater detail infra, selection and/or persistence can be effected manually or automatically.

The replacement engine 106 can be employed to substitute an original module with a modified version of the original module. In operation, the replacement engine 106 can intercept a link command based at least upon the content included within the data repository or other storage component. In other words, the replacement engine 106 can review the link command based at least in part on the content of the user data repository which can contain the persisted user-selected aggregates. In the event that the original link command refers to an aggregate that has a user-defined copy of a module and/or aggregate included within the data repository, the replacement engine can prompt the interception.

Further the intercepted original link command can be modified to point to the copy of the one or more aggregates maintained within the data repository. Accordingly, at link time, a particular application of the build system can employ the copy(ies) thereby not affecting the original build system. As will be understood, because a copy of the aggregate can be employed at link time, a modification of any module and/or aggregate by a particular user/application will not affect subsequent employment of the build system by other users/applications.

In one aspect, the subject innovation is directed to a system and/or methodology that employs an analysis engine 104 that facilitates analyzing complex build systems via build simulation. As well, the analysis engine 104 can effect persistence of modules and libraries to be replaced. Other aspects are directed to employment of a replacement engine 106 that can replace a dynamic library via link-time command interception and replacement. In other words, the analysis engine 104 and replacement engine 106 of the disclosed aspects can be employed to facilitate multiple users to utilize a single build system whereas each user can employ the build system without affecting the employment of the build system by the other users.

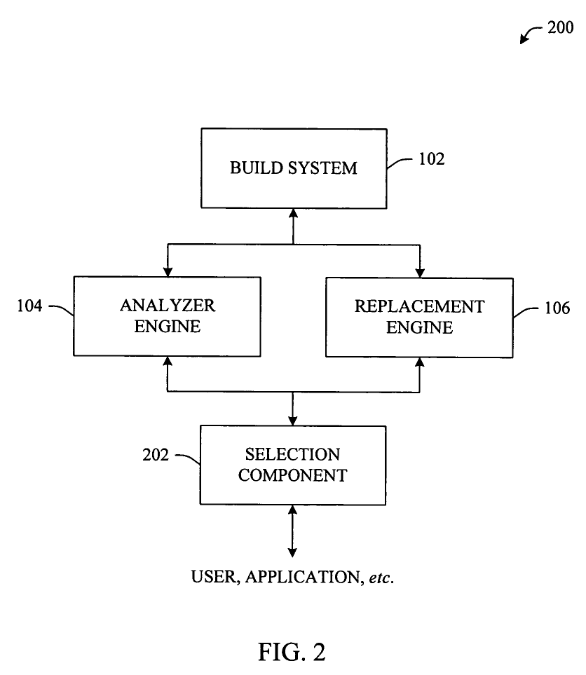

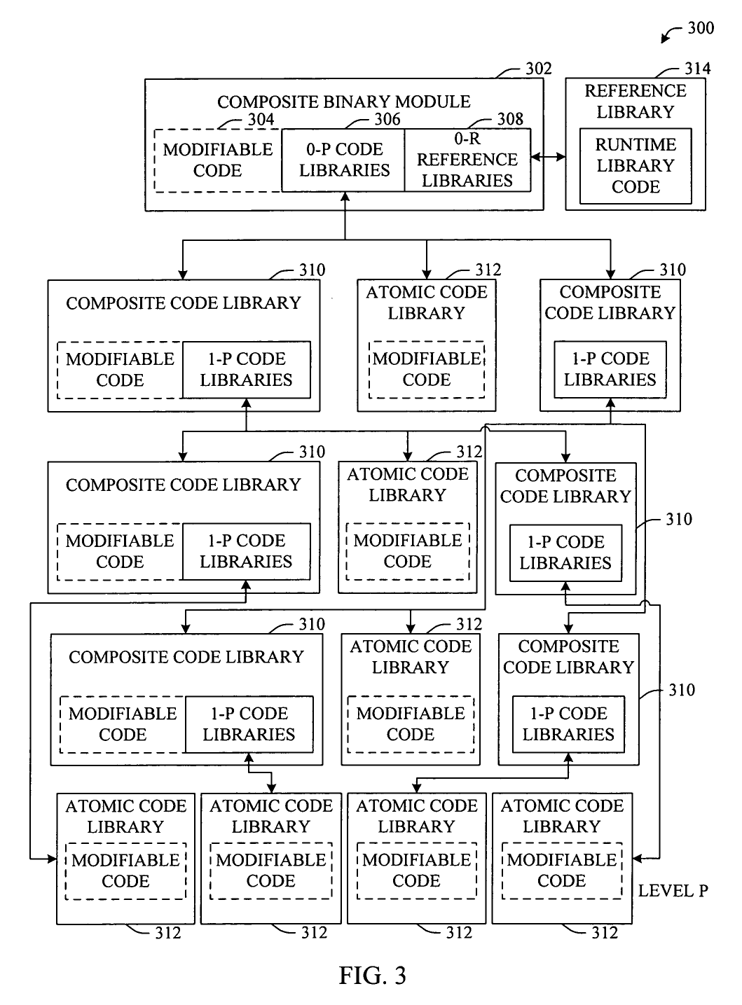

Referring now to FIG. 2, an alternative system 200 that facilitates source code replacement via dynamic build analysis and command interception is shown. In particular, system 200 can include a build system 102, an analysis engine 104, a replacement engine 106 and a selection component 202. As described supra, the analysis engine 104 can be employed to identify one or more decomposable modules of the build system 102. Additionally, the analysis engine 104 can be employed to decompose all of the identified (or user selected) modules into one or more aggregates (e.g., artifacts). As will be described with reference to FIG. 3, these one or more artifacts can be complex and/or atomic code libraries.

As further described supra, the replacement engine 106 can be employed to switch a copied (and possibly modified) artifact with an original artifact at build time. In furtherance thereto, the replacement engine 106 can be employed to intercept an original link command and to modify the original link command to point to the copied artifact. This switch facilitates modifying the modules in the build system while employing one or more copied artifacts upon building the modules.

A selection component 202 can be employed to select modules and/or artifacts from the list(s) generated by the analysis engine 104. By way of example, a user can employ the selection component 202 identify a module and/or aggregate (or group thereof) to copy and/or replace. This selection can be conveyed to the analysis engine 104 whereby the selected components can be persisted into a data store (e.g., data repository). Once persisted, the replacement engine 106 can interrogate the data store to determine the selected (and possibly modified) components. As such, the replacement engine 106 can monitor link commands that correspond to any one of the persisted components.

Upon detection of a link command that corresponds to a component that has a persisted counterpart component, the replacement engine 106 can generate a modified link command thereby effecting the build system 102 to employ the copy of the component. This is particularly useful when a user modifies a module and/or artifact. As well, it will be understood that this system can be employed as a backup system thereby ensuring that the original build system can be replicated irrespective of any modification.

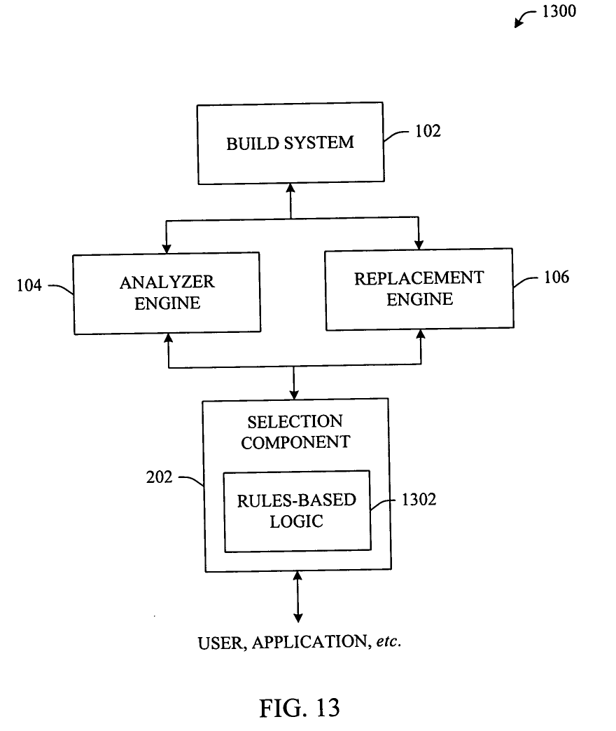

It is to be appreciated that the selection component 202 can be manually and/or automatically employed. In alternate aspects, rules-based logic and/or artificial intelligence (AI) mechanisms can be utilized to an automate action that a user desires to be performed. These alternate aspects will be better understood upon a review of FIGS. 13 to 15 that follow.

FIG. 3 illustrates a decomposable binary module list 300. A decomposable binary module list 300 can be illustrated as a hierarchical structure as shown.

By way of example, composite binary module 302 can include modifiable code 304, 0 to P code libraries, where P is an integer, and 0 to R reference libraries, where R is an integer. Elements illustrated at level P are composed of elements at level P+1. It is to be appreciated that 0 to P code libraries and 0 to R reference libraries can be referenced to individually or collectively as code library 304 and reference library 306.

The types of elements shown in FIG. 3 include binary modules, composite libraries, atomic code libraries and reference libraries. Binary modules can be composed of code, code libraries or reference libraries. Composite code libraries can be composed of optional code and 1 or more code libraries (including other composite code libraries.) Atomic code libraries can include code but do not include additional code libraries. Finally, reference libraries can contain references to code that will be available at run-time as opposed to build time. These reference libraries contain no code that is to be copied and/or modified by the user. It is to be appreciated that the dashed lines illustrated in FIG. 3 denote modifiable code.

It is further to be understood that code library 306 can include composite libraries 310 and/or atomic libraries 312. The list of all binary modules that the build system can build can be decomposed into complex or atomic code libraries (e.g., 310, 312 respectively). It is to be understood that complex libraries are libraries that can be composed of 1 or more disparate libraries (e.g., complex or atomic.) On the other hand, atomic libraries can not be further decomposed into a set of libraries. Atomic libraries are simple aggregates.

Referring again to FIG. 3, a dependency (e.g., decomposition) graph 300 is shown. In particular, the decomposition graph 300 of FIG. 3 represents a build composition graph for an exemplary binary module. This graph 300 is a bounded p-tiered tree where the top-most node is the binary module and each child node's child nodes are the code libraries (e.g., complex or atomic) that compose it. The deepest level P, where P is an integer, is the level at which all elements at that level are single aggregates, either atomic code 310 libraries or reference libraries 314.

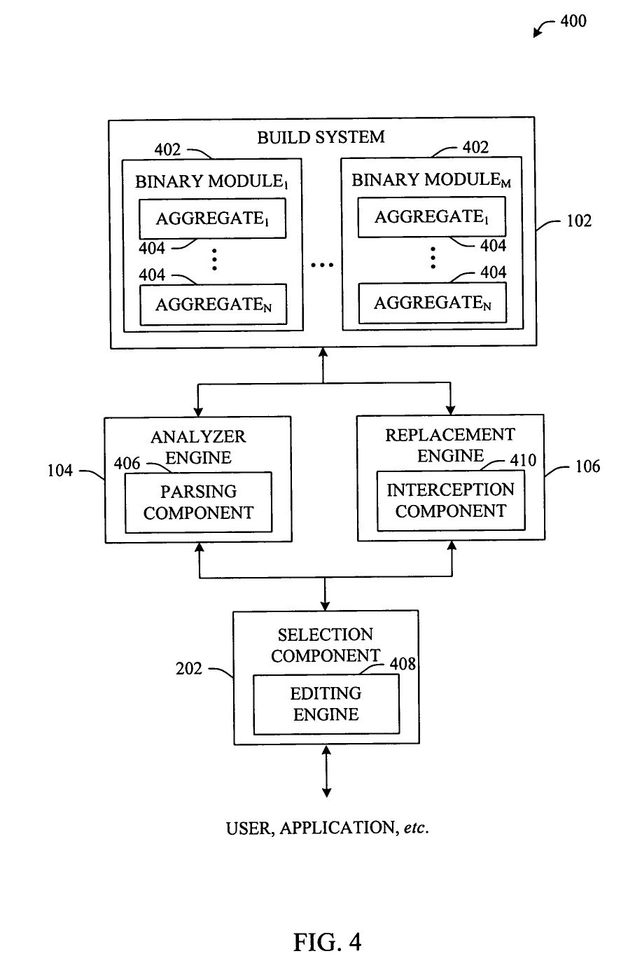

Turning now to FIG. 4, a system 400 that facilitates modifying a build system 102 is shown. The system 400 can generally include a build system 102, an analysis engine 104, a replacement engine 106 and a selection component 202. As illustrated, build system 102 can include 1 to M binary modules, where M is an integer. It will be appreciated that 1 to M binary modules can be referred to individually or collectively as binary modules 402. Additionally, as illustrated in FIG. 3, each disparate binary module 402 can include 1 to N aggregates (e.g., complex libraries, atomic libraries, reference libraries). It is to be understood and appreciated that 1 to N aggregates can be referred to individually or collectively as aggregate 404.

As described above, in one aspect, analysis engine 104 can be employed to identify decomposable binary modules and aggregates, 402 and 404 respectively. More particularly, a parsing component 406 can be included within the analysis engine 104 in order to identify and separate decomposable binary modules 402 and associated aggregates 404 therewith.

In one example, a user (or application) can choose modules and/or aggregates to copy, persist and/or modify. A selection component 202 can be employed to facilitate choosing which module(s) and/or aggregate(s) to decompose and/or persist to a data repository. An editing engine 408 can be employed in connection with the selection component 202 thus enabling a user (and/or application) to modify a particular, or group of, module(s)/aggregate(s). Although the editing component 408 is illustrated inclusive of the selection component 202, it is to be understood and/or appreciated that the editing engine 408 can be separate and/or remote from the selection component 202.

Once chosen via the selection component 202, the choices can be persisted into any chosen data repository or memory storage location. In accordance with an aspect, the persistence of what modules/library combinations a user wishes to replace with modified code and under what conditions these should be replaced (e.g., only if building project “X”) can be effected.

Additionally, system 400 can include a replacement engine 106 having an interception component 410. The interception component 410 can enable the system 400 to intercept a link command that corresponds to a module/aggregate persisted in the data repository. Accordingly, the system can generate a modified link command thereby sending the modified link command to the linker utility upon a build. As a result, the build system 102 can generate a build of the system that replaces one or more components (e.g., modules, aggregates) with the persisted user/application modified counterparts.

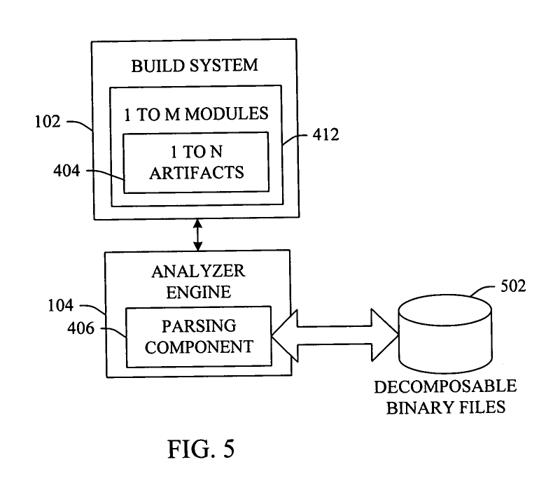

FIG. 5 illustrates operation of the analysis engine 104. With reference to FIG. 5, the build system 102 of this aspect is a system that allows for the creation, management and building of software projects. It will be understood that this functionality can be scalable to allow for the management and building of large scale projects involving hundreds or even thousands of binary modules. The build system 102 can contain source code, artifacts (e.g., dependency information files, directory structure, . . . ) that represents how to build code. Additionally, the build system 102 can include the tools to build the code (e.g., compilers, linkers, . . . ).

In this build system 102, source files can be compiled into object files and code libraries. The code libraries can then linked at a later stage into binary modules. Aspects of the innovation are directed to expanding the current capabilities of conventional build systems. More particularly, the subject innovation can be employed to enable a user and/or application to copy (and/or modify) artifacts without affecting the original build system 102.

The analysis engine 104 can be employed to understand the artifact formats of the build system 102. Accordingly, the analysis engine 104 can include a parsing component 406 that parses these artifacts to create a decomposable binary module list and/or a decomposition graph (e.g., FIG. 3). In one example, the decomposable binary module list can be generated by a static analysis of the artifacts of the build system 102.

The decomposition graph can be generated by a build system 102 simulation of the component (e.g., module) in question. For example, a selection component (not shown) as described supra can be employed to select a specific module and/or artifact to modify and/or simulate. A component under simulation can either be a top level binary module or a code library at any level of the decomposition graph. This hierarchical relationship can be better understood upon a review of FIG. 3 above. As shown, these decomposable binary files can be persisted into data repository 502 or any other desired storage facility.

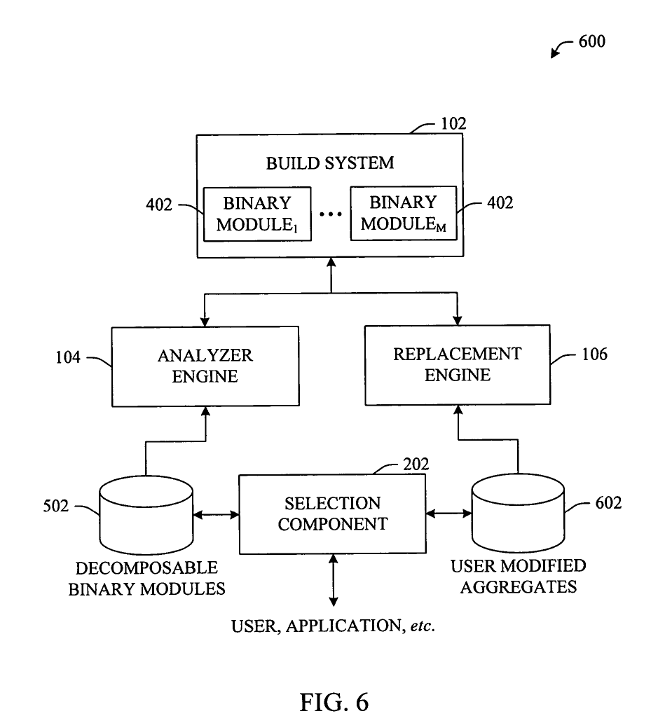

Referring now to FIG. 6, a system 600 that facilitates employing a modified build system without affecting the original build system is shown. Generally, system 600 can include the original build system 102, an analysis engine 104, a replacement engine 106 and a selection component 202. In operation, the system can allow a user to modify a particular module, or group of modules, without affecting the original build system 102.

The analysis engine 104 can identify the decomposable binary modules 402 associated with the build system 102. Once identified, the decomposable binary modules can be persisted into data repository 502. A selection component 202 can be employed to identify desired modules (or aggregates) 402 to modify. The modified aggregates can be persisted into data repository 602. These modified aggregates can be employed to facilitate a modified version of build system 402 without altering the original build system 102. Although multiple data repositories (e.g., 502, 602) are shown, it is to be understood that a single data repository can be employed in connection with other aspects. As well, it will be appreciated that the data repository(ies) can be local or remote as desired.

The replacement engine 106 can be employed to monitor and/or inspect link commands associated with build system 102. As such, the replacement engine 106 can intercept link commands that correspond to persisted user modified aggregates. Accordingly, the replacement engine 106 can modify the appropriate link command(s) to reference the persisted user modified aggregates thus, enabling the build system to employ appropriate modified aggregates.

The replacement engine 106 can be responsible for building the user replaceable (e.g., modified) libraries based on information in the data repository 502. This build can be performed prior to the linking of any binary modules 402 in the build system 102. The replacement engine 106 can also be responsible for insuring that any binary modules 402 that the user wishes to modify via replacement libraries (e.g., data repository 602) are correctly constructed.

Binary modules 402 modified via replacement libraries can be constructed by intercepting the build system 102 commands to the linker utility (not shown). For each link command sent to the linker, the replacement engine 106 can inspect the binary module 402 that is to be created. If this binary module 402 is to have user code injected into it from the data repository 602, the replacement engine 106 can look up the list of replaceable code libraries the user wants to inject into the binary module 402 from the data repository 602. As stated supra, the link command can then be re-authored with the appropriate replacement libraries overwriting the original libraries. The link command is then forwarded on to the linker utility (not shown). In this scenario the original build system 102 is not aware of the replacement.

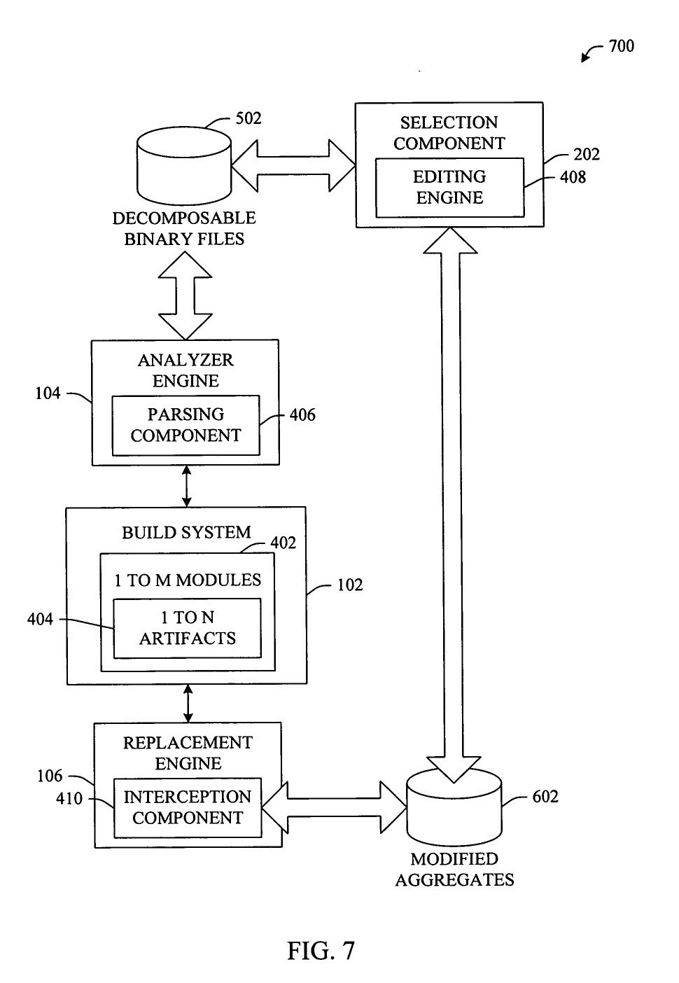

FIG. 7 illustrates still another aspect of a system 700 that facilitates simulating a modified build system. System 700 can include a build system 102 having 1 to M binary modules 402, where M is an integer. Additionally, the system 700, and more specifically the binary modules 402 can include 1 to N artifacts 404, where N is an integer. An analysis engine 104 having a parsing engine 406 is also provided. As described above, the parsing engine 406 of the analysis engine 104 can be employed to identify the decomposable binary modules (e.g., subset of modules 402) of build system 102. The identified decomposable binary files can be persisted into data repository 502.

A selection component 202 together an editing component 408 can be employed to modify a selected decomposable module and/or aggregate thus enabling a modified build of the build system 102. As illustrated, modified aggregates can be persisted into data repository 602. A replacement engine 106 can employ an interception component 410 to identify and modify link commands that correspond to modified aggregates persisted in data repository 602. In other words, the replacement engine 106 can be employed to modify a link command that references an original aggregate that has a modified counterpart persisted in the data repository 602. Thus, the persisted modified counterparts can be employed to build the modules utilizing the modified aggregates.

The data repositories 502, 602 can be persistent stores for the system user. Accordingly, the data repositories 502, 602 can contain the following library replacement rules. First, the list of all binary modules can be constructed from aggregate code libraries for a given build system. Second, a rule can be employed that identifies the logical condition(s) and unique identifier(s) of the binary module for which to inject replaceable libraries. The list of aggregate source libraries to replace can also be set forth in a rule. It will be appreciated that it is not necessary that the aggregate source libraries be first order components. In other words, the aggregate source libraries can be in any level of the decomposition graph supplied by the analysis engine 104. Finally, the location of the user copy of the replacement source libraries can be set forth in a rule or set of rules.

A build system shim can be employed to effect building modules. This build system shim can be a shim that is installed to hook build commands and linker commands in the build system 102. The shim can be deployed between build system commands to effect building a binary module and the dependency rule engine, compiler and/or linker. An implementation of the injection of the shim is often dependent upon the build system 102. Aspects can include spoofing of the dependency rule engine and build tools via renaming and replacing, installing shim earlier in the search path, pointing build system to shim via environment variables in the build system, etc.

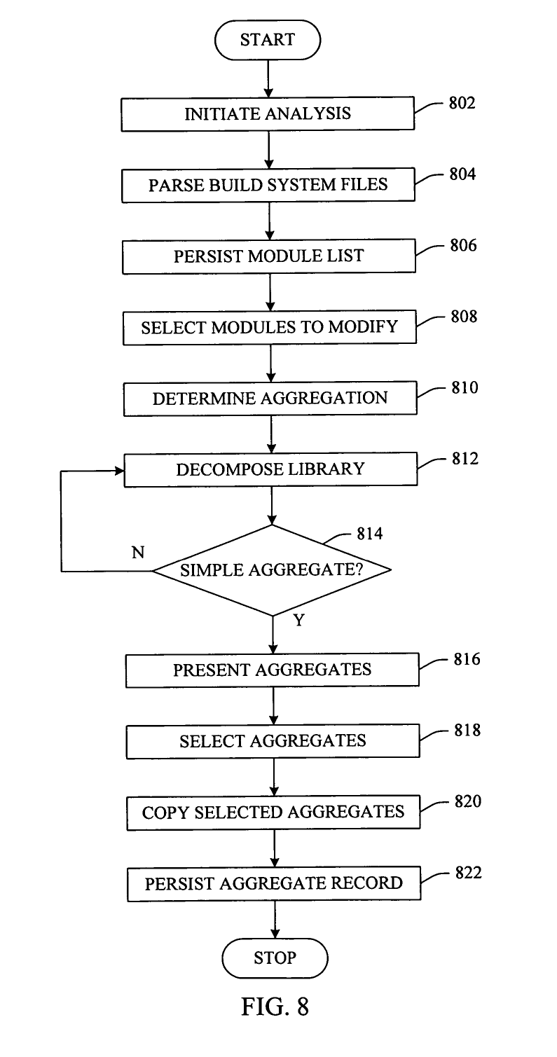

FIGS. 8 to 12 that follow are included to provide systematic context to the invention and are not intended to limit the invention in any way. More particularly, the figures that follow describe aspects with reference to three individual computational phases. First is a discussion of an analysis phase. Next is a discussion of a pre-link phase. Finally, a discussion of a link phase of the build system is provided.

Referring now to FIG. 8, there is illustrated a methodology of the build system analysis phase in accordance with an aspect of the invention. While, for purposes of simplicity of explanation, the one or more methodologies shown herein, e.g., in the form of a flow chart, are shown and described as a series of acts, it is to be understood and appreciated that the subject invention is not limited by the order of acts, as some acts may, in accordance with the invention, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the invention.

The analysis phase can analyze the build system and present the system user with information on what source code can be modified dynamically without modifying the build system. It is to be appreciated that the process set forth in FIG. 8 can be repeated for each binary module to copy and/or modify. At 802, an analysis can be initiated. More particularly, a build system analysis can be manually or automatically initiated at 802. In one aspect, a user can instantiate the analysis engine whereby the analysis engine can be initialized with the location and type of the build system. During this act, a build command hook can be injected into the build system that allows build simulations and hooking of linker commands.

At 804, build system files can be parsed. In other words, at 804, the build system artifacts that contain information on what binary modules are produced and how they are produced are located and parsed. Accordingly, a build system module list can be generated. This build system module list can represent all binary modules that are constructed from aggregate code libraries.

The module list is persisted at 806. In one aspect, the list is persisted into a local data repository. However, alternative aspects exist whereas the list is persisted into a remote data repository.

A user can select which module(s) to modify from the list at 808. In other words, at 808, a user can select one or more modules from the list to inject modified code into. As described above, this selection can be the result of a user manual selection. In alternative aspects, rules-based logic and/or AI reasoning can be employed to automatically select modules from the list. For example, modules can be automatically presented to the user based on a heuristic mechanism that detects usage patterns.

At 810, module aggregation can be determined. In one aspect, a build system simulation can be run to determine the module aggregation. In other words, the analysis engine can run a simulated build for the selected module. It is to be appreciated that, in one aspect, during the simulation, no on-disk files are modified or created, thus leaving the build system unaltered. The simulation can be isolated and performed only with respect to the selected binary module. This simulation generates a list of first order components (e.g., FIG. 3 supra).

At 812, each code library is decomposed to determine its composites. At 814, a determination is made if the component is a simple aggregate. If not, the component is decomposed to determine its composites. It will be appreciated that, for each component that is identified as a code library, a build simulation is run to determine its composites. This simulation is run until a component can no longer be decomposed because it is either an import library (contains no source code) or is an atomic library. In other words, this process is recursive until a simple aggregate is reached at 814. The simulation information is captured to create the decomposition graph for the binary module as illustrated in FIG. 3 supra.

At 816, the replaceable aggregates can be presented to the user. In one aspect, at 816, a decomposition graph can be rendered to a user and/or application. This rendering enables selection of the individual aggregates to replace and/or modify. At 818, aggregates to replace and/or modify can be selected. In one aspect, the user manually selects aggregates to modify that will be replaced for the subject module. In accordance with each selection, at 820, a copy of the aggregate source code and build artifacts are made and copied to the location specified by the user and/or application. The copy is modified as necessary to allow building outside of the build system directory structure (e.g., modifications to disk path locations, . . . ). At 822, the record of module/aggregates can be persisted in data repository (e.g., user repository). This act can persist also user selections in the data repository.

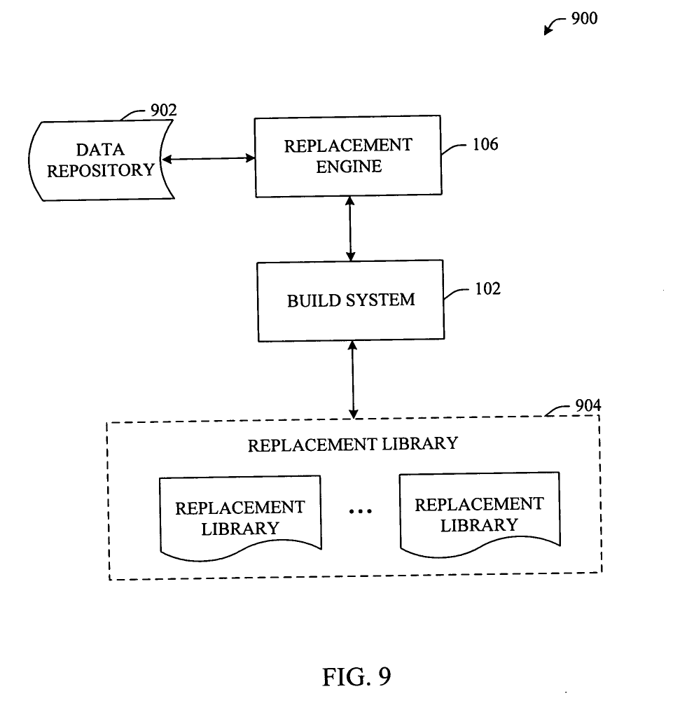

FIG. 9 illustrates a system 900 that represents a pre-link phase in accordance with an aspect of the subject innovation. Generally, system 900 includes a build system 102 and a replacement engine 106. In operation, the replacement engine 106 reads a list of aggregates from the data repository 902. The build system 102 is called by the replacement engine 106 to build replacement libraries 904. Accordingly, the replacement libraries 904 can be built. It will be appreciated that, although two replacement libraries are illustrated in FIG. 9, any number of replacement libraries 904 can be built by the build system 102. The number of replacement libraries 904 can correspond to the number of components contained within the list maintained in the data repository 902.

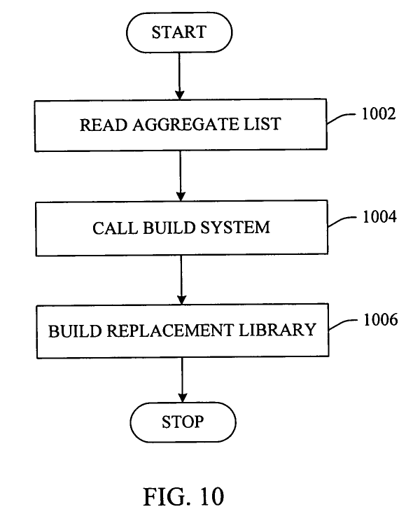

FIG. 10 illustrates a methodology of a pre-link phase in accordance with an aspect. It will be appreciated that, in one aspect, before any of the build system binary modules can be linked, the user replacement code libraries can be built. At 1002, an aggregate list can be read. As described with reference to FIG. 9, the aggregate list can be read by a replacement engine. The replacement engine can read the list of replacement code libraries from the data repository. Additionally, it is to be understood that this act can be manually or automatically effected in accordance with disparate aspects of the innovation.

Once the aggregate list is read, the build system can be called at 1004. The replacement engine can call the build system to build the replacement code libraries since the build system can contain the global rules and utilities to build the replacement code libraries. Accordingly, at 1006, replacement libraries can be built. These replacement libraries can be representative of manual and/or automatic modifications to original aggregates. The build order for the replacement libraries can be obtained during the analysis phase from the decomposition graph (as illustrated, for example, in FIG. 3).

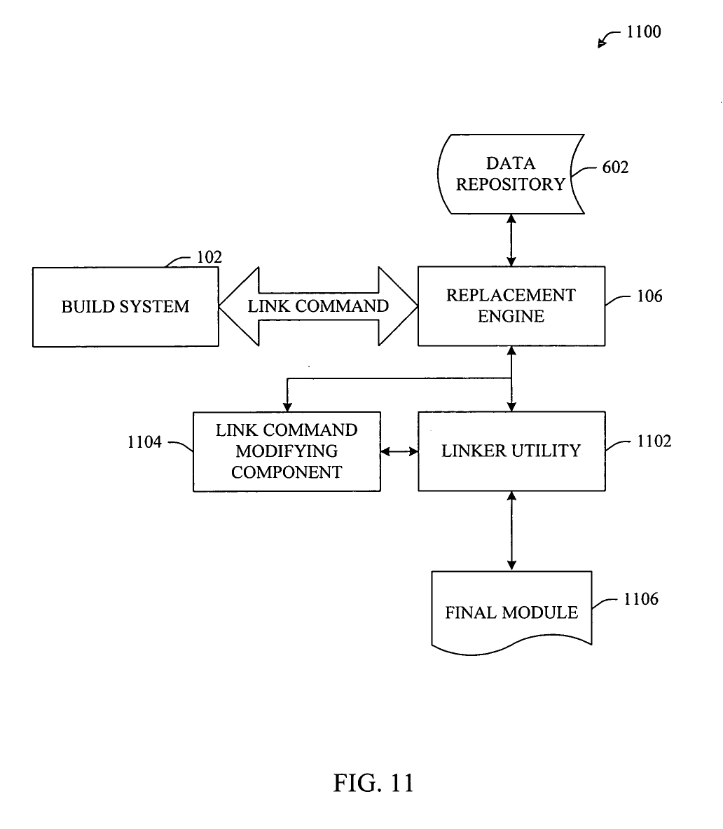

FIG. 11 illustrates a system 1100 that represents a link phase in accordance with an aspect of the innovation. Generally, the system 1100 can include a build system 102, a replacement engine 106, a link utility 1102 and a link command modifying component 1104. Although the link command modifying component 1104 is illustrated separate from the replacement engine 106 (or other component), it is to be understood that the link command modifying component 1104 and corresponding functionality, can be incorporated into the replacement engine 106 (or other system component (e.g., linker utility 1102)) without departing from the spirit and/or scope of the invention.

In operation, the build system 102 can send a link command for each module corresponding to the build system 102 as shown. Accordingly, the replacement engine 106 can intercept the link command and read the replacement module list from the data repository 602. The replacement engine 106 can determine if the subject module libraries are to be replaced. If the module libraries are not to be replaced, the link command can be sent directly to the linker utility 1102 without modification.

If however, the module libraries are to be replaced, the link command can be modified by the link command modifying component 1104 and sent to the linker utility 1102 as shown. Thus, final module(s) 1104 can be generated that employ the modified replacement libraries. As well, because replacement modules are generated, the original build system 102 modules are not affected and are still available for disparate users, systems and/or applications to employ.

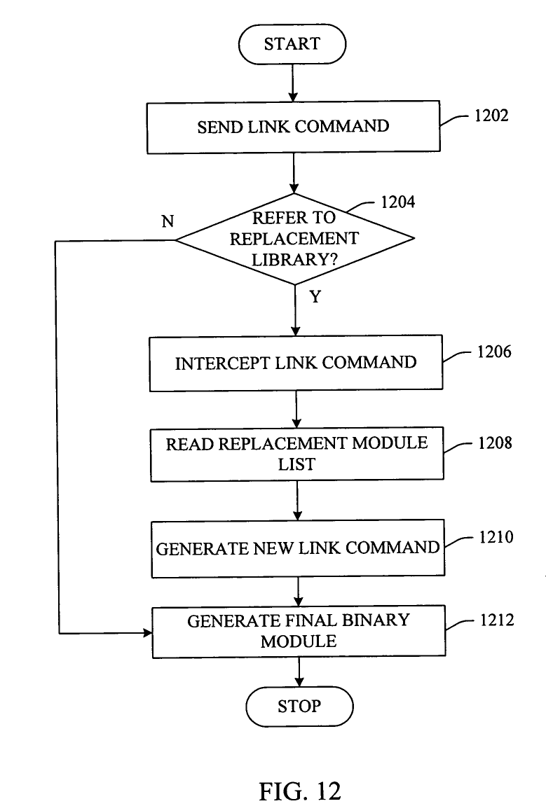

FIG. 12 illustrates a methodology of a link phase in accordance with an aspect. It is to be appreciated and understood that the link phase represents the third phase in which the build system links one or more binary modules from a set of aggregated source code libraries. It will further be understood that, in accordance with an aspect, the set of aggregated source code libraries can include user/application modified code.

At 1202, a link command is sent. In one aspect, the build system initiates a link command to a linker utility. This command can contain the parameters for linkage along with the list of aggregates which are to be included in composing a subject binary module. The command is interrogated (e.g., analyzed) at 1204 to determine if the aggregates referenced therein are included within a replacement library (e.g., user modified library).

If the aggregates are contained within a replacement library, the link command can be intercepted at 1206. In one aspect, a replacement engine can effect interception of the link command. In this aspect, the replacement engine intercepts the command if it determines the command refers to a replaceable binary module in the user data repository (e.g., data repository 602). As described supra, a build system shim can facilitate the replacement engine to intercept and inspect the commands at this time.

At 1208, the replacement module list is read. Accordingly, the list of code libraries that are to be replaced with respect to the subject module are identified and read. In accordance with the determination at 1204 that the link command refers to replacement libraries, at 1210, a new and/or modified link is established that references the replacement libraries. As such, each link command reference that identifies a replaced aggregate is modified and/or replaced by a reference to the user copy from the data repository

At 1212, a final binary module can be generated. In other words, the modified link command is sent to the linker utility and the final binary module is generated. If, at 1204, a determination is made that the link command does not refer to a replacement library, the process can jump 1212. Accordingly, the unaltered link command can be sent to the linker utility and the final binary module can be generated.

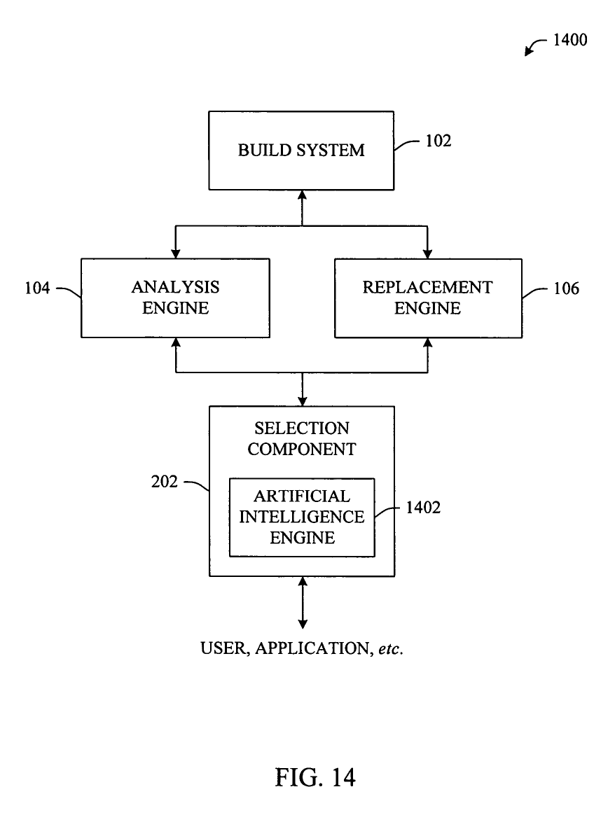

With reference now to FIG. 13, an alternate aspect of a system (e.g., 1300) is shown. Generally, system 1300 can include a build system 102, an analysis engine 104, a replacement engine 106, a selection component 202 and a rules-based logic component 1302. In accordance with this alternate aspect, an implementation scheme (e.g., rule) can be applied to select decomposable modules and/or aggregates to copy and/or modify with respect to a given build system. It will be appreciated that the rules-based implementation can automatically and/or dynamically select modules and/or aggregates based upon any predefined criterion. In response thereto, the rule-based implementation can copy and apply specified modification to the module and/or aggregate by employing a predefined and/or programmed rule(s) based upon any desired criteria. It is to be appreciated that any preference can be effected in a pre-defined or pre-programmed manner in the form of a rule. The rules-based logic described with reference to FIG. 13 can be employed in addition to or in place of AI-based components described with reference to FIG. 14 that follows.

FIG. 14 illustrates a system 1400 that employs AI-based reasoning which facilitates automating one or more features in accordance with the subject invention. System 1400 can include a build system 102, an analysis engine 104, a replacement engine 106, a selection component 202 and an AI component 1402.

The subject invention (e.g., in connection with selecting, modifying and/or copying modules/aggregates) can employ various AI-based schemes for carrying out various aspects thereof. For example, a process for determining which aggregates to create a user copy in a data repository can be facilitated via an automatic classifier system and process.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed.

A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naive Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the subject invention can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be used to automatically learn and perform a number of functions, including but not limited to determining, according to a predetermined criteria, when an aggregate should be selected, copied, modified, etc. This criteria can include, but is not limited to, the amount of memory on a device, the number of modules/aggregates included in the system, the type of data, and the importance of the data.

It is to be appreciated that, although the rules-based logic component 1302 and the AI component 1402 are illustrated integral to the selection component 202, these alternative logic and reasoning components can be employed in separate autonomous components. As well, the functionality of these logic and reasoning components can be included within the analysis engine 104 and/or replacement engine 106 without departing from the spirit and scope of the disclosure and claims appended hereto.

In yet another aspect, a heuristic event analysis can be employed. As described supra, a user can manually select a module to analyze and/or copy in accordance with an aspect. As well, a selection of one or more modules can be suggested to the user based on usage patterns, interesting events, and the age and frequency of these events.

By way of example, suppose a user attempts to edit a source file. If the source file maps to a module in the list generated in the analysis phase, the analysis engine can autonomously determine, at edit time, which module(s) are most likely to be copied based upon previous interesting events. It will be appreciated and understood that, in many cases, source code can map to more than one module in the system.

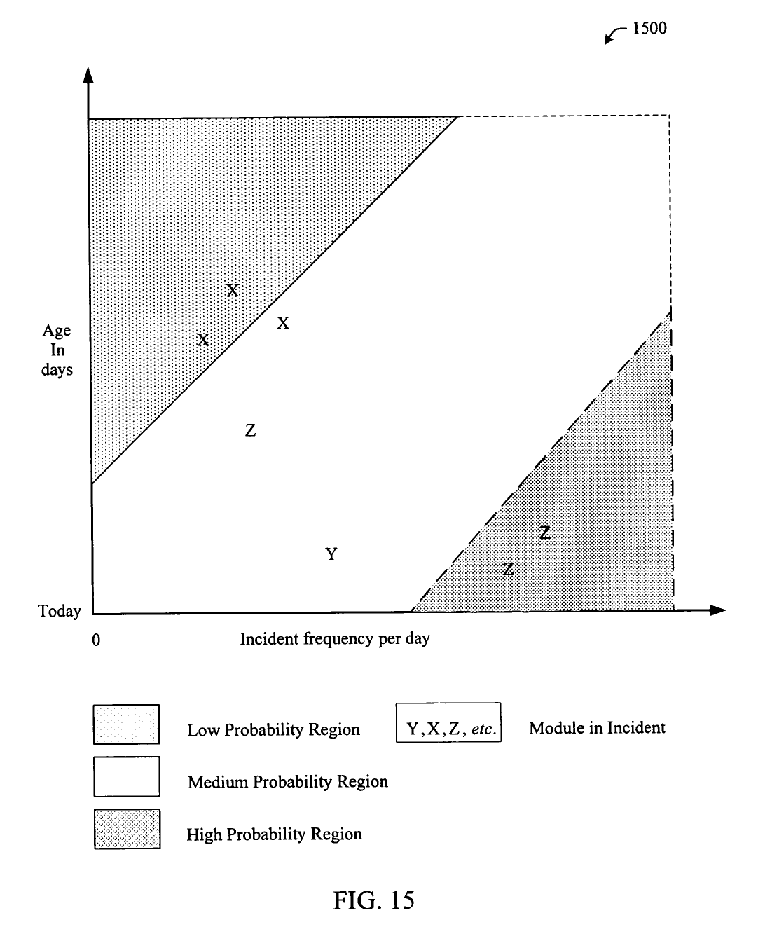

Interesting events can include debugging events and software faults. For example, debugging events can include stepping through code in a module and setting debugging instructions with regard to a module such as stopping in an instruction in the module. Software faults can include faults that occur while an instruction corresponding to the module is being executed and/or faults that occur when the operation system is servicing a request for the module. As illustrated in the graph 1500 of FIG. 15, these events can be given weight based on importance and age. As interesting events occur they can be stored in the data repository or other desired store. The graph 1500 can be used to determine the level of probability that a certain module code should be copied and/or modified. At code edit time the user can be automatically presented with the highest probability suggestions of which modules should be made modifiable based upon previous events.

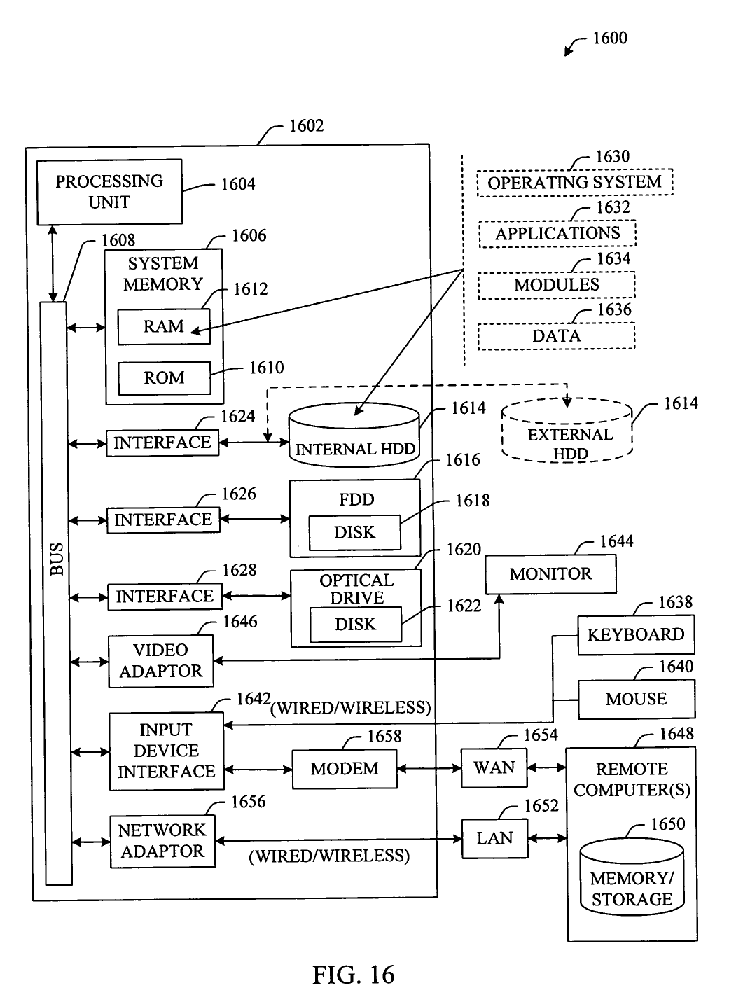

Referring now to FIG. 16, there is illustrated a block diagram of a computer operable to execute the disclosed architecture of simulating a build process. In order to provide additional context for various aspects of the subject invention, FIG. 16 and the following discussion are intended to provide a brief, general description of a suitable computing environment 1600 in which the various aspects of the invention can be implemented. While the invention has been described above in the general context of computer-executable instructions that may run on one or more computers, those skilled in the art will recognize that the invention also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the invention may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 16, the exemplary environment 1600 for implementing various aspects of the invention includes a computer 1602, the computer 1602 including a processing unit 1604, a system memory 1606 and a system bus 1608. The system bus 1608 couples system components including, but not limited to, the system memory 1606 to the processing unit 1604. The processing unit 1604 can be any of various commercially available processors. Dual microprocessors and other multi-processor architectures may also be employed as the processing unit 1604.

The system bus 1608 can be any of several types of bus structure that may further interconnect to a memory bus (with or without a memory controller), a peripheral bus, and a local bus using any of a variety of commercially available bus architectures. The system memory 1606 includes read-only memory (ROM) 1610 and random access memory (RAM) 1612. A basic input/output system (BIOS) is stored in a non-volatile memory 1610 such as ROM, EPROM, EEPROM, which BIOS contains the basic routines that help to transfer information between elements within the computer 1602, such as during start-up. The RAM 1612 can also include a high-speed RAM such as static RAM for caching data.

The computer 1602 further includes an internal hard disk drive (HDD) 1614 (e.g., EIDE, SATA), which internal hard disk drive 1614 may also be configured for external use in a suitable chassis (not shown), a magnetic floppy disk drive (FDD) 1616, (e.g., to read from or write to a removable diskette 1618) and an optical disk drive 1620, (e.g., reading a CD-ROM disk 1622 or, to read from or write to other high capacity optical media such as the DVD). The hard disk drive 1614, magnetic disk drive 1616 and optical disk drive 1620 can be connected to the system bus 1608 by a hard disk drive interface 1624, a magnetic disk drive interface 1626 and an optical drive interface 1628, respectively. The interface 1624 for external drive implementations includes at least one or both of Universal Serial Bus (USB) and IEEE 1394 interface technologies. Other external drive connection technologies are within contemplation of the subject invention.

The drives and their associated computer-readable media provide nonvolatile storage of data, data structures, computer-executable instructions, and so forth. For the computer 1602, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the invention.

A number of program modules can be stored in the drives and RAM 1612, including an operating system 1630, one or more application programs 1632, other program modules 1634 and program data 1636. All or portions of the operating system, applications, modules, and/or data can also be cached in the RAM 1612. It is appreciated that the invention can be implemented with various commercially available operating systems or combinations of operating systems.

A user can enter commands and information into the computer 1602 through one or more wired/wireless input devices, e.g., a keyboard 1638 and a pointing device, such as a mouse 1640. Other input devices (not shown) may include a microphone, an IR remote control, a joystick, a game pad, a stylus pen, touch screen, or the like. These and other input devices are often connected to the processing unit 1604 through an input device interface 1642 that is coupled to the system bus 1608, but can be connected by other interfaces, such as a parallel port, an IEEE 1394 serial port, a game port, a USB port, an IR interface, etc.

A monitor 1644 or other type of display device is also connected to the system bus 1608 via an interface, such as a video adapter 1646. In addition to the monitor 1644, a computer typically includes other peripheral output devices (not shown), such as speakers, printers, etc.

The computer 1602 may operate in a networked environment using logical connections via wired and/or wireless communications to one or more remote computers, such as a remote computer(s) 1648. The remote computer(s) 1648 can be a workstation, a server computer, a router, a personal computer, portable computer, microprocessor-based entertainment appliance, a peer device or other common network node, and typically includes many or all of the elements described relative to the computer 1602, although, for purposes of brevity, only a memory/storage device 1650 is illustrated. The logical connections depicted include wired/wireless connectivity to a local area network (LAN) 1652 and/or larger networks, e.g., a wide area network (WAN) 1654. Such LAN and WAN networking environments are commonplace in offices and companies, and facilitate enterprise-wide computer networks, such as intranets, all of which may connect to a global communications network, e.g., the Internet.

When used in a LAN networking environment, the computer 1602 is connected to the local network 1652 through a wired and/or wireless communication network interface or adapter 1656. The adaptor 1656 may facilitate wired or wireless communication to the LAN 1652, which may also include a wireless access point disposed thereon for communicating with the wireless adaptor 1656.

When used in a WAN networking environment, the computer 1602 can include a modem 1658, or is connected to a communications server on the WAN 1654, or has other means for establishing communications over the WAN 1654, such as by way of the Internet. The modem 1658, which can be internal or external and a wired or wireless device, is connected to the system bus 1608 via the serial port interface 1642. In a networked environment, program modules depicted relative to the computer 1602, or portions thereof, can be stored in the remote memory/storage device 1650. It will be appreciated that the network connections shown are exemplary and other means of establishing a communications link between the computers can be used.

The computer 1602 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

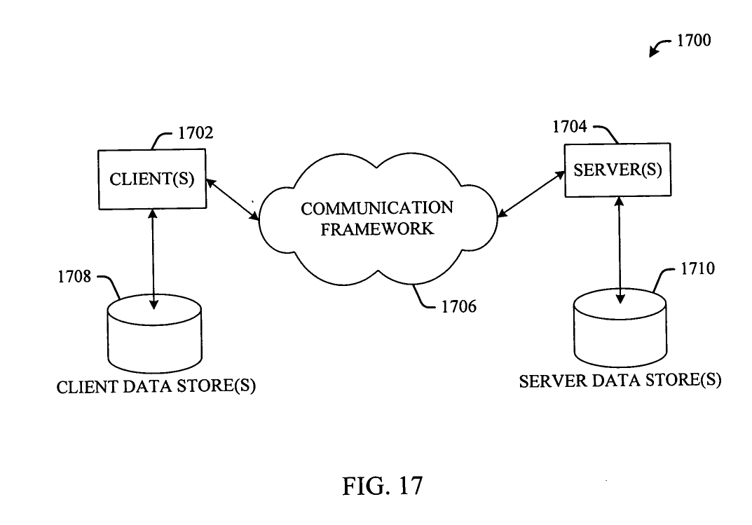

Referring now to FIG. 17, there is illustrated a schematic block diagram of an exemplary computing environment 1700 in accordance with the subject invention. The system 1700 includes one or more client(s) 1702. The client(s) 1702 can be hardware and/or software (e.g., threads, processes, computing devices). The client(s) 1702 can house cookie(s) and/or associated contextual information by employing the invention, for example.

The system 1700 also includes one or more server(s) 1704. The server(s) 1704 can also be hardware and/or software (e.g., threads, processes, computing devices). The servers 1704 can house threads to perform transformations by employing the invention, for example. One possible communication between a client 1702 and a server 1704 can be in the form of a data packet adapted to be transmitted between two or more computer processes. The data packet may include a cookie and/or associated contextual information, for example. The system 1700 includes a communication framework 1706 (e.g., a global communication network such as the Internet) that can be employed to facilitate communications between the client(s) 1702 and the server(s) 1704.

Communications can be facilitated via a wired (including optical fiber) and/or wireless technology. The client(s) 1702 are operatively connected to one or more client data store(s) 1708 that can be employed to store information local to the client(s) 1702 (e.g., cookie(s) and/or associated contextual information). Similarly, the server(s) 1704 are operatively connected to one or more server data store(s) 1710 that can be employed to store information local to the servers 1704.

What has been described above includes examples of the invention. It is, of course, not possible to describe every conceivable combination of components or methodologies for purposes of describing the subject invention, but one of ordinary skill in the art may recognize that many further combinations and permutations of the invention are possible. Accordingly, the invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates simulating a build system, comprising:
an analyzer engine that parses one or more artifacts of the build system; and
a replacement engine that builds of a copy of the one or more artifacts and persists the copy of the one or more artifacts in a data repository, the replacement engine facilitates modifying a link command to insert the copy of the one or more artifacts into the build system prior to a build.

2. The system of claim 1, the replacement engine intercepts an original link command and generates the modified link command based at least in part on the content of the data repository.

3. The system of claim 1, further comprising a selection component that facilitates a selection of the one or more artifacts to copy.

4. The system of claim 3, the selection component further comprises an editing engine that facilitates a modification of the one or more selected artifacts, the copy of the one or more artifacts corresponds to the modification of the one or more selected artifacts.

5. The system of claim 1, the analyzer engine generates a list of one or more decomposable modules, the one or more decomposable modules can be decomposed into the one or more artifacts.

6. The system of claim 5, the one or more artifacts comprises at least one of a complex library and an atomic library.

7. The system of claim 6, the complex library comprises at least one of a disparate complex library and a disparate atomic library.

8. The system of claim 6, the analyzer engine generates a decomposition graph of a subset of the one or more decomposable modules.

9. The system of claim 8, further comprising a selection component that facilitates selection of a subset from the list of one or more decomposable modules.

10. The system of claim 9, the analyzer engine decomposes the subset from the list of one or more decomposable modules into the one or more aggregates.

11. The system of claim 10, the selection component facilitates selection of a subset of the one or more aggregates.

12. The system of claim 11, the replacement engine builds the copy the subset of the one or more aggregates and persists the copy into the data repository.

13. The system of claim 11, the replacement engine facilitates generation of a modified module, the modified module employs the copy of the one or more artifacts.

14. The system of claim 1, further comprising an artificial intelligence (AI) component that infers an action that a user desires to be automatically performed.

15. A computer-readable medium having stored thereon computer-executable instructions for carrying out the system of claim 1.

16. A method for modifying a build system, comprising:
analyzing the build system to identify a list of decomposable modules;
decomposing at least one of the list of decomposable modules, the at least one of the decomposable modules generates one or more aggregates;
selecting one of the one or more aggregates;
copying the selected one of the one or more aggregates;
modifying a link command to point to the copied selected one of the one or more aggregates; and
generating a build based at least upon the modified link command.

17. The method of claim 16, further comprising modifying the selected one of the one or more aggregates.

18. The method of claim 17, further comprising intercepting the link command based at least in part on the selected one of the one or more aggregates.

19. A system that facilitates modifying a build system, comprising:
means for identifying a decomposable module associated with the build system;
means for decomposing the identified decomposable module into one or more aggregates;
means for selecting a subset of the one or more aggregates;
means for copying the subset of the one or more aggregates into a data repository;
means for modifying the subset of the one or more aggregates; and
means for inserting the modified subset of the one or more aggregates into the build system based at least in part on content in the data repository.

20. The system of claim 19, further comprising means for intercepting a link command and means for generating a modified link command that facilitates a modified build based at least in part on one of the modified subset of the one or more aggregates.
